(19) United States
(12) Patent Application Publication
(10) Pub. No.: US 2009/0298194 A1
(43) Pub. Date: Dec. 3, 2009

(54) BINDING DRUGS OF ABUSE

(76) Inventors: Anthony Peter Francis Turner, Bedfordshire (GB); Sergey Anatoliyovich Piletsky, Bedfordshire (GB); Olena Volodimirivna Piletsky, Bedfordshire (GB); Antonio Guerreiro, Bedfordshire (GB); Iva Chianella, Bedfordshire (GB); Maria Romero-Guerra, Madrid (ES)

Correspondence Address: STITES & HARBISON PLLC, 1199 NORTH FAIRFAX STREET, SUITE 900, ALEXANDRIA, VA, 22314, US

(21) Appl. No.: 12/293,360

(22) PCT Filed: Mar. 19, 2007
(86) PCT No.: PCT/GB2007/000945

§ 371 Date: Apr. 13, 2009

(30) Foreign Application Priority Data
Mar. 17, 2006 (GB) 0605427.4

(51) Int. Cl. G01N 30/00

(52) U.S. Cl. 436/178

(57) ABSTRACT

Drugs of abuse (e.g. cocaine) and related substances are selectively bound by an adsorbent which comprises units derived from carboxylic acids of formula A or B: (A): R₁R₂C(CF₃)—CO₂H; (B): R₃═C(CF₃)—CO₂H or derivatives thereof. The adsorbent may be a polymer, or a solid support onto which the carboxylic acid, derivative or polymer has been grafted. The preferenced acid is 2-trifluoromethyl acrylic acid. A drug can be selectively bound from a mixture, and recovered using an eluant comprising an organic acid.

### TECHNICAL FIELD

Broadly, the present invention describes materials capable of binding drugs of abuse and related compounds, and their application in analytical chemistry, environmental, clinical, forensic, defence, security and food analyses. The preferred binding materials have a high affinity to drugs of abuse such as cocaine, and can be used for purification of these compounds, extraction and enrichment from variety of samples, measurement, visualisation and for therapeutic applications.

The use of controlled drugs has increased dramatically during the past three decades. This has stimulated development of analytical tools capable of detecting these compounds in a variety of physiological or food samples. The modern techniques most used for drug detection are solid-phase extraction (SPE) or liquid-liquid extraction (LLE) followed by measurements using GC-MS. There is an urgent need for the development of materials facilitating sample preparation, improving cost-effectiveness of the analysis and increased speed of testing. The principal goal of the invention was to design an affinity matrix which would possess high affinity to individual drug or a range of drugs of abuse or illicit drugs or metabolites thereof, and that could be used for the extraction, purification, pre-concentration, separation or detection of these compounds using measurement methods such as chromatography, including high-pressure liquid chromatography (HPLC) (possibly in combination with mass-spectrometry (MS)), gas chromatography and enzyme-linked immunoadsorbent assay (ELISA), spectroscopy or sensors.

### BACKGROUND ART

### REFERENCES

| Patent | Country | Issued | Title |
|---|---|---|---|
| U.S. Pat. No. 6,057,161 | USA | May 2, 2000 | Method for determination of drugs of abuse |
| | | | in biological samples |
| U.S. Pat. No. 6,913,917 | USA | Jul. 5, 2005 | Anti-cocaine catalytic antibody |
| U.S. Pat. No. 6,156,431 | USA | Dec. 5, 2000 | Extraction material comprising treated |
| | | | silica and method for determination of |
| | | | gamma-hydroxybutyrate |

### OTHER REFERENCES

1. Kriz, D., and K. Mosbach, 1994. Competitive amperometric morphine sensor based on an agarose immobilized molecularly imprinted polymer. Anal. Chim. Acta 300 (1-3):71-75.

2. Andersson, L I., R. Miller, G. Vlatakis, and K. Mosbach. 1995. Mimics of the Binding Sites of Opioid Receptors Obtained by Molecular Imprinting of Enkephalin and Morphine. Proc. Natl. Acad. Sci. USA 92:4788-4792.

3. Hsu, H. C., L. C. Chen and K. C. Ho. 2004. Colorimetric detection of morphine in a molecularly imprinted polymer using an aqueous mixture of Fe3+ and [Fe(CN)(6)](3-). Anal. Chim. Acta. 504:141-147.

4. Holdsworth, C. I., M. C. Bowyer, C. Lennard and A. McCluskey, 2005, Formulation of cocaine-imprinted polymers utilizing molecular modelling and NMR analysis, Australian Journal of Chemistry, 58:315-320.

5. Zurutuza, A., S. Bayoudh, P. A. G. Cormack, L. Dambies, J. Deere, R. Bischoff and D. C. Sherrington, 2005, Molecularly imprinted solid-phase extraction of cocaine metabolites from aqueous samples, Anal. Chim. Acta, 542:14-19.

6. He, Y. H., J. R. Lu, M. Liu, J. X. Du and F. Nie, 2005, Determination of morphine by molecular imprinting-chemiluminescence method, Journal of Analytical Toxicology, 29:528-532.

7. Ho, K. C., W. M. Yeh, T. S. Tung and J. Y. Liao, 2005, Amperometric detection of morphine based on poly(3,4-ethylenedioxythiophene) immobilized molecularly imprinted polymer particles prepared by precipitation polymerization, Anal. Chim. Acta, 542:90-96.

8. Yeh, W. M. and K. C. Ho, 2005, Amperometric morphine sensing using a molecularly imprinted polymer-modified electrode, Anal. Chim. Acta, 542:76-82.

9. Piletska, E. V., M. Romero-Guerra, I. Chianella, K. Karim, A. R. Turner and S. A. Piletsky, 2005, Towards the development of multisensor for drugs of abuse based on molecular imprinted polymers, Anal. Chim. Acta, 542:111-117.

Several different materials were used in the past as affinity materials for drugs of abuse such as morphine and cocaine, including: substantially underivatized styrene-divinyl benzene (SDVB) resin (U.S. Pat. No. 6,057,161), silica having both phenyl and propylsulfonic acid functional groups (U.S. Pat. No. 6,913,917), antibodies (U.S. Pat. No. 6,913,917) and molecularly imprinted polymers (MIPs) (references 1-9). They all have some problems related to inefficient or non-selective recovery of target compounds from real samples or, as in the case of antibodies, insufficient stability of affinity matrix.

### DISCLOSURE OF THE INVENTION

The present invention describes the application of materials containing fluorinated carboxylic acids in the selective binding of drugs of abuse.

Materials capable of binding drugs of abuse and structurally related compounds (e.g. metabolites) are disclosed, together with their application in analytical chemistry, medicine, environmental, clinical, forensic, defence, security and food analyses. Specifically materials capable of binding drugs of abuse are constructed from the derivatives of trifluoromethyl carboxylic acids, such as for example 2-trifluoromethyl acrylic acid. The adsorbents synthesised from these derivatives (usually polymeric) have a high affinity for drugs of abuse and can be used for the extraction, enrichment and purification of these compounds. The affinity and selectivity of synthesised materials could be optionally enhanced by using a molecular imprinting process.

In a first aspect the invention provides a method of separating a drug of abuse (preferably cocaine or an analogue thereof) or a structurally related compound (e.g. a metabolite) from a mixture containing it by contacting the mixture with an adsorbent material that binds the drug of abuse, preferably selectively. The adsorbent material comprises units derived from one or more fluorocarboxylic acids of formula A and/or B, or derivatives thereof:

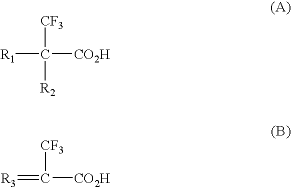

where R₁ is selected from hydrogen, optionally-substituted alkyl or cycloalkyl, optionally-substituted aryl or heteroaryl, optionally-substituted amine, —OR or —SR where R is alkyl, cycloalkyl, aryl or heteroaryl and is optionally substituted;

R₂ is selected from optionally-substituted alkyl or cycloalkyl, optionally-substituted aryl or heteroaryl, optionally-substituted amine, OR or SR where R is as defined above, or is a group containing a double or triple carbon-carbon bond; and

R₃ is selected from optionally-substituted alkylene or cycloalkylene, oxygen or sulfur.

Alkyl and alkylene groups generally have 1-6 C atoms. Aryl and heteroaryl generally have up to 12 C atoms. “Optionally substituted” refers to the possibility that one or more H atoms are replaced by a substituent suitably selected from halogen, OR, SR, NR₂, —CO—R, aryl or heteroaryl where R is as defined above.

If the carboxylic acid does not contain a carbon-carbon multiple bond, use will generally be made of a derivative which does, e.g. an ester of vinyl or allyl alcohol.

The adsorbent material may be a polymer, particularly a molecularly imprinted polymer (‘MIP’) prepared by polymerisation of (A) or (B) or a derivative thereof in the presence of a drug (e.g. cocaine) or a structural analogue thereof (e.g. benzoylecgonine). In another aspect the invention provides such MIPs.

The mixture from which the target compound is separated is commonly aqueous, which can be problematic with conventional MIPs.

Thus in different aspects the invention provides:

(1). Synthesis of the adsorbent from polymerisable derivatives of fluorinated carboxylic acids by polymerisation.

(2). Synthesis of the molecularly imprinted polymer in the presence of drug of abuse using polymerisable derivatives of fluorinated carboxylic acids.

(3). Grafting of fluorinated carboxylic acids to the surface of beads or membranes.

(4). Application of the synthesised adsorbents for the extraction, enrichment, removal or purification of drugs of abuse or related compounds, or their detection.

Preferred target compounds have cationic character, usually due to the presence of amine functionalities. Particularly preferred target compounds include heroin, morphine, 6-acetyl morphine, morphine-3-glucuronide, codeine, cocaine, benzoylecgonine, ecgonine methyl ester, amphetamine, methamphetamine and lysergic acid diethylamide.

### BRIEF DESCRIPTION OF THE DRAWING

FIG. 1 depicts chromatographic separation of cocaine and some structural and functional analogues using MIP imprinted with cocaine (P1) prepared in toluene with 2-TFMAA as functional monomer and corresponding Blank polymer (C1).

### MODES FOR CARRYING OUT THE INVENTION

The first embodiment describes the synthesis of an adsorbent from polymerisable derivatives of fluorinated carboxylic acids. Normally a fluorinated carboxylic acid monomer, containing a polymerizable double bond, or a mixture of monomers, is mixed together with a cross-linker and a radical initiator, usually with a solvent. The cross-linker used for the polymer preparation is usually selected from acrylate, methacrylate, vinyl, allyl or styrene derivatives, with preferred examples including ethylene glycol dimethacrylate, divinylbenzene, divinylnaphthalene, divinyl ether and their mixtures. The monomer(s) and cross-linker are generally present in the polymerisation mixture in an amount of from about 10 to 80 vol. %, and more preferably in an amount of from about 40 to 80 vol. %. The monomer(s) may constitute 5-20 vol % of the mixture of monomers and cross-linker. The solvent may be selected from aliphatic hydrocarbons, aromatic hydrocarbons, esters, alcohols, ketones, ethers, butyl alcohols, isobutyl alcohol, dimethyl sulfide, formamide, cyclohexanol, H₂O, glycerol, aqueous solutions of salts (e.g. sodium acetate), solutions of soluble polymers, and mixtures thereof. Preferred examples include toluene and chloroform. A pore-forming component may be present in the monomer mixture, suitably in an amount of from 5 to 60 vol %. Conventional free-radical generating polymerisation initiators may be employed to initiate polymerisation. Examples of suitable initiators include peroxides such as OO-t-amyl-O-(2ethylhexyl)monoperoxycarbonate, dipropylperoxydicarbonate, and benzoyl peroxide, and azo compounds such as azobisisobutyronitrile, 2,2′-azobis(2-amidinopropane)dihydrochloride, 2,2′-azobis(isobutyramide)dihydrate and 1,1′-azobis (cyclohexane carbonitrile). The initiator is generally present in the polymerisation mixture in an amount of from about 0.2 to 5% by weight of the monomers. Several different forms of polymerisations may be used, including radical polymerisation, living polymerisation, ionic polymerisation, suspension or emulsion polymerisation or any other form known to practitioners in the art. The preferred kind of polymerisation is a radical polymerisation. The polymerisation can be initiated by UV irradiation or thermally. The monomers which can be used for adsorbent preparation include derivatives of fluorinated carboxylic acids, preferably being vinyl monomers, allyl monomers, acetylenes, acrylates, or methacrylates. Those skilled in the art could select monomers and cross-linkers suitable for a particular system.

The second embodiment describes synthesis of the molecularly imprinted polymer in the presence of a drug of abuse (or analogue or related compound) using polymerisable derivatives of fluorinated carboxylic acids. In principle polymerised fluorinated carboxylic acids already have affinity sufficient for a variety of practical applications. If however the polymerised fluorinated carboxylic acids do not have sufficient affinity or selectivity for an intended application their performance could be improved through a molecular imprinting process. This invention also teaches formation of the polymer in the presence of a corresponding drug or related compound or its chemical derivative, which serves as a template for self-assembling of the monomer molecules in a pattern complementary to the structure of the template. Following polymerisation, extraction of the template will leave in the polymer structure imprints with binding sites capable of selective re-binding of the template molecule or its analogues. The monomer mixture used for molecular imprinting typically includes cross-linker, polymerisable derivative of fluorinated carboxylic acid, optionally other monomer(s) capable of modulating polymer morphological or binding properties, initiator and drug template, usually mixed in an appropriate solvent. The drugs of abuse and their metabolites may be selected from, but are not restricted to, tetrahydrocannabinol, heroin, morphine, 6-acetyl morphine, morphine-3-glucuronide, codeine, cocaine, benzoylecgonine, ecgonine methyl ester, amphetamine, methamphetamine, lysergic acid diethylamide, phencyclidine, barbiturates, such as butabarbital, pentobarbital, secobarbital, phenobarbital, alphenal, and amobarbital, benzodiazepines such as oxazepam and chlorodiazepoxide, tricyclic antidepressants such as doxepin, imipramine, and amitriptyline or corresponding other metabolites. The cross-linker used for the polymer preparation is usually selected from acrylate, methacrylate, vinyl, allyl or styrene derivatives, with non-exclusive examples of ethylene glycol dimethacrylate, divinylbenzene, divinylnaphthalene, divinyl ether and their mixtures. The monomers including cross-linker are generally present in the polymerisation mixture in an amount of from about 10 to 80 vol. %, and more preferably in an amount of from about 40 to 80 vol. %. The monomer(s) may constitute 5-20 vol % of the mixture of monomers and cross-linker. The solvent may be selected from a group including aliphatic hydrocarbons, aromatic hydrocarbons, esters, alcohols, ketones, ethers, butyl alcohols, isobutyl alcohol, dimethyl sulfide, formamide, cyclohexanol, H₂O, glycerol, aqueous solutions of salts (e.g. sodium acetate), solutions of soluble polymers, and mixtures thereof. Preferred solvents include toluene and chloroform. The pore-forming component is present in the monomer mixture in an amount of from 5 to 60 vol %. Conventional free-radical generating polymerisation initiators may be employed to initiate polymerisation. Examples of suitable initiators include peroxides such as OO-t-amyl-O-(2ethylhexyl) monoperoxycarbonate, dipropylperoxydicarbonate, and benzoyl peroxide, as well as azo compounds such as azobisisobutyronitrile, 2,2′-azobis(2-amidinopropane) dihydrochloride, 2,2′-azobis(isobutyramide)dihydrate and 1,1′-azobis (cyclohexane carbonitrile). The initiator is generally present in the polymerisation mixture in an amount of from about 0.2 to 5% by weight of the 30 monomers. The polymerisation can be initiated by UV irradiation or thermally. The polymerisation could be performed by different methods known for experienced artisan, such as bulk polymerisation, polymerisation in suspension and emulsion, precipitation polymerisation, living polymerisation etc.

The third embodiment describes grafting of fluorinated carboxylic acid-based polymer, which could be imprinted or non-imprinted material, to the surface of beads or membrane. It might be desirable to graft fluorinated carboxylic acids or their polymers to the surfaces of prepared articles such as pre-formed beads, membranes, capillaries or fibres. Grafting could be achieved in a variety of ways known to practitioners in art. Thus the surface of corresponding inorganic or polymeric materials can be activated with functional groups capable of covalent attachment of corresponding derivatives of fluorinated carboxylic acids. The typical example of chemical reaction used for this could be the formation of Schiff's base, disulfide bonds, S-metal bond, formation of esters etc. Another type of grafting could include radical grafting with radical initiator, chemically or physically immobilised on the surface of beads or membranes. Plasma grafting also can be used for production of affinity adsorbents.

The fourth embodiment describes the application of the synthesised adsorbents for the purification of drugs of abuse, their analogues and metabolites, and their extraction and enrichment from a variety of samples, or their detection. A typical example of this application could be solid phase extraction of drug of abuse from biological or food samples. These adsorbents can be used in combination with quantification methods such as chromatography, including high-pressure liquid chromatography (HPLC) and HPLC in combination with mass-spectrometry (MS), gas chromatography and enzyme-linked immunoadsorbent assay (ELISA) or sensors. These adsorbents could also be an essential part of sensor device, microfluidic unit or detection kit. All these proposed applications are covered by the present invention.

The present invention will now be further described particularly with references to the following non-limited examples.

### EXAMPLE 1

### Synthesis of cross-linked 2-trifluoromethyl acrylic acid (TFMAA)

The polymer was synthesised by mixing 1 g of 2-trifluoromethyl acrylic acid (TFMAA), 4 g of cross-linker, ethylene glycol dimethacrylate (EGDMA), 0.1 g of initiator (1,1′-azobis (cyclohexanecarbonitrile)), and 5 g of solvent dimethylformamide (DMF). The polymer was illuminated by UV for 20 min using a Hönle 100 UV lamp (intensity 0.157 W/cm²) and was kept at 80° C. for 1 day. After synthesis, polymer was ground and wet-sieved with methanol to obtain particles of 63-106 μm.

### EXAMPLE 2

### Synthesis of Molecularly Imprinted Polymers for Cocaine, Deoxyephedrine, Methadone and Morphine

The polymer compositions are given in the Table 1. An excess of functional monomer proportional to the template (˜4 times) was used in order to ensure good interactions with all template molecules and consequent formation of maximum number of binding sites. Blank polymers were prepared using the same composition but in the absence of template. The polymers were polymerised using Hönle 100 UV lamp for 20 min and then incubated in the oil bath at 80° C. for 1 day. Polymers were ground and sieved using methanol. The fraction between 45 and 106 μm was collected and packed in stainless steel HPLC columns (50×4.6 mm) using Slurry Packer model 1666 (Alltech, UK).

TABLE 1
Compositions of the polymers.

| Poly- | | | | | | 1,1-azobis- |
|---|---|---|---|---|---|---|
| mer | Template | 2-TFMAA | EGDMA | Toluene | | (carbonitrile) |
| P1 | Cocaine, 250 mg | 460 mg | 4.3 g | 5 | g | 50 mg |
| C1 | — | 460 mg | 4.3 g | 5 | g | 50 mg |
| P2 | Methadone, | 403.2 mg | 4.35 g | 5 | | 50 mg |
| | 250 mg | | | | | |
| C2 | — | 403.2 mg | 4.35 g | 5 | | 50 mg |
| P3 | Morphine, | 980 mg | 3.8 g | 5 | g | 50 mg |
| | 250 mg | | | | | |
| C3 | — | 980 mg | 3.8 g | 5 | g | 50 mg |
| P4 | Deoxyephedrine, | 935 mg | 3.8 g | 5 | g | 50 mg |
| | 250 mg | | | | | |
| C4 | — | 935 mg | 3.8 g | 5 | g | 50 mg |

### EXAMPLE 3

### Testing of Polymer Performance in Chromatographic Conditions

The HPLC columns prepared in Example 2 were used for analysis of polymer binding to the drugs in aqueous conditions. The evaluation experiments were carried out using an HPLC system which included a ConstaMetric-3200 solvent delivery system (LDC Analytical, UK), PerkinElmer ISS-100 automatic injection system and a Waters Lambda-Max Model 481 LC Detector (UK). HPLC analysis here and in the following example was performed at a flow-rate of 1.0 mL·min⁻¹ and monitored by UV detector at 260 nm. Injection amounts were 20 μg in 20 μL injection volume. All reported chromatographic data represent the results of 3 -5 concordant experiments. The standard deviation of the measurements was below 5%. All polymers demonstrated very high affinity to drugs in water to the degree that it was impossible to elute adsorbed compound from the column using water. In order to achieve elution, the eluant was acidified with acetic acid. The results of testing indicate relative affinity of TFMAA-based polymers to the corresponding drugs (Table 2). Capacity factors (K′) were determined from K′=(t−t₀)/t₀, where t is the retention time of a given species and t₀ is the retention time of the void marker (acetone). It is possible to conclude that the affinity of polymers could be further improved through molecular imprinting process.

TABLE 2
Capacity factors for polymers in aqueous environment.

| Polymers | HPLC conditions | K′ |
|---|---|---|
| P1 | 20% Acetic acid | 6.6 |
| C1 | 20% Acetic acid | 2.5 |
| P2 | 20% Acetic acid | 10.5 |
| C2 | 20% Acetic acid | 7.5 |
| P3 | 5% Acetic acid | 1.3 |
| C3 | 5% Acetic acid | 1.1 |
| P4 | 20% Acetic acid | 1 |
| C4 | 20% Acetic acid | 0.7 |

### EXAMPLE 4

### Testing of the Selectivity of Blank Polymer and Polymer Imprinted with Cocaine

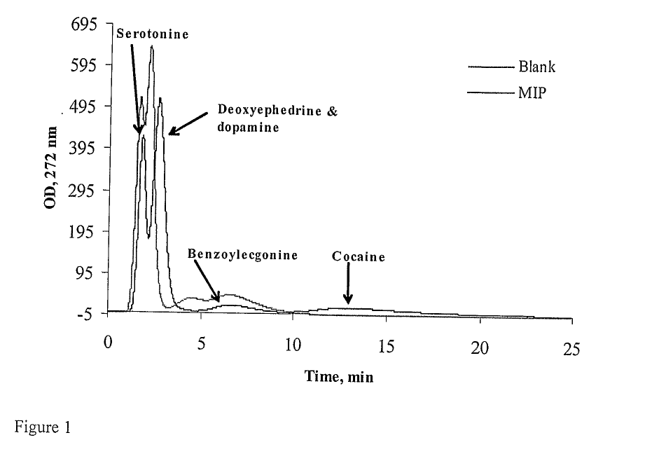

HPLC columns (50×4.6 mm) prepared as above, containing the P1 (cocaine imprinted) and C1 (corresponding blank) polymers. The HPLC columns were used for separation of the cocaine from a mixture containing functional (deoxyephedrine, serotonin and dopamine) and structural (benzoylecgonine) analogues. The results are shown in FIG. 1. It was found that baseline separation of the cocaine from the other analogues was achieved. Results suggest that P1 polymer had superior affinity towards the cocaine in comparison with other analogues. The corresponding blank polymer C1 did not demonstrate the baseline separation of the cocaine from its closest analogue benzoylecgonine, showing that the selectivity of TFMAA polymers can be improved by molecular imprinting.

1. A method of separating a target compound which is a drug of abuse or metabolite or analogue thereof from a mixture containing it by contacting the mixture with an adsorbent material that selectively binds the target compound, the adsorbent material comprising units derived from one or more fluorocarboxylic acids of formula A and/or B, or derivatives thereof: 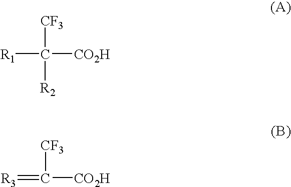
where R₁ is selected from hydrogen, optionally-substituted alkyl or cycloalkyl, optionally-substituted aryl or heteroaryl, optionally-substituted amine, —OR or —SR where R is alkyl, cycloalkyl, aryl or heteroaryl and is optionally substituted;
R₂ is selected from optionally-substituted alkyl or cycloalkyl, optionally-substituted aryl or heteroaryl, optionally-substituted amine, OR or SR where R is as defined above, or is a group containing a double or triple carbon-carbon bond; and
R₃ is selected from optionally-substituted alkylene or cycloalkylene, oxygen or sulfur.

2. A method according to claim 1 wherein said adsorbent material comprises units derived from one or more carboxylic acid derivatives selected from salts, esters, thioesters, amides and nitriles.

3. A method according to claim 1 wherein said fluorocarboxylic acid is 2-trifluoromethyl acrylic acid.

4. A method according to claim 1 wherein said adsorbent material comprises a polymer prepared by polymerising a monomer having a carbon-carbon multiple bond which is employed in the polymerisation, said monomer being a fluorocarboxylic acid of formula (A) or (B) or a derivative thereof.

5. A method according to claim 4 wherein the polymerisation also involves a cross-linker.

6. A method according to claim 5 wherein the cross-linker is selected from acrylates, methacrylates, vinyl derivatives, allyl derivatives and styrene derivatives.

7. A method according to claim 6 wherein the cross-linker is one or more of ethylene glycol dimethacrylate, divinyl benzene, divinylnaphthalene and divinyl ether.

8. A method according to claim 4, wherein said polymerising step employs free radical polymerisation.

9. A method according to claim 4, wherein said polymerising step employs living polymerisation, ionic polymerisation or suspension or emulsion polymerisation.

10. A method according to claim 1 wherein said adsorbent material is prepared by grafting a carboxylic acid of formula (A) or (B), a derivative thereof, or a polymer of such a carboxylic acid or derivative thereof, onto a solid support.

11. A method according to claim 10 wherein said solid support is in the form of beads, fibres, capillaries or a membrane.

12. A method according to claim 1 wherein said adsorbent material is a molecularly imprinted polymer prepared by polymerising one or more acids of formula (A) or (B) or derivatives thereof in the presence of a target compound.

13. A method according to claim 1 wherein said adsorbent material is a porous polymer prepared in the presence of a pore-forming component.

14. A method according to claim 1 including a subsequent step of eluting the target compound from the adsorbent material to which it is bound.

15. A method according to claim 14 wherein said step (c) employs an eluant comprising an acid.

16. A method according to claim 15 wherein the eluant comprises an organic acid.

17. A method according to claim 1 wherein said target compound has cationic character.

18. A method according to claim 1 wherein said target compound has an amine functionality.

19. A method according to claim 1 wherein said target compound is selected from tetrahydrocannabinol, heroin, morphine, 6-acetyl-morphine, morphine-3-glucuronide, codeine, cocaine, benzoylecgonine, ecgonine methyl ester, amphetamine, methamphetamine, lysergic acid diethylamide, phencyclidine, barbiturates, benzodiazepines and tricyclic antidepressants.

20. A method according to claim 17 wherein said target compound is selected from heroin, morphine, 6-acetyl morphine, morphine-3-glucuronide, codeine, cocaine, benzoylecgonine, ecgonine methyl ester, amphetamine, methamphetamine and lysergic acid diethylamide.

21. A method according to claim 1 wherein the mixture containing the target compound is an aqueous solution.
